(19) United States
(12) Patent Application Publication
(10) Pub. No.: US 2026/0264681 A1
(43) Pub. Date: Sep. 10, 2026

(54) CONTROL DEVICE, TERMINAL DEVICE, CONTROL METHOD, AND STORAGE MEDIUM

(71) Applicant: HONDA MOTOR CO., LTD., Tokyo (JP)

(72) Inventors: Takahiro OSAWA, Tokyo (JP); Kohei MIYAMOTO, Tokyo (JP)

(73) Assignee: HONDA MOTOR CO., LTD., Tokyo (JP)

(21) Appl. No.: 19/554,675

(22) Filed: Mar. 3, 2026

(30) Foreign Application Priority Data
Mar. 5, 2025 (JP) 2025-034258

(51) Int. Cl. B60W 30/18; B60W 60/00; G01C 21/36

(52) U.S. Cl. CPC B60W 30/18009; B60W 60/0025; G01C 21/3676

(57) ABSTRACT

A control device for a moving object capable of autonomously moving from a parking position to a predetermined exit position includes a processor configured to acquire a user’s instruction and control the moving object. The processor can acquire a reservation instruction before acquiring an exit instruction. The reservation instruction is an instruction to move the moving object. The exit instruction is an instruction to move the moving object parked at the parking position to the predetermined exit position. The processor causes the moving object to transition to a first state, which is a movement preparation state, in response to acquiring the reservation instruction, and causes the moving object to transition to a second state, in which the moving object is moved, in response to acquiring a predetermined instruction after the reservation instruction when the moving object is in the first state.

### RELATED APPLCATION

This application is based on and claims priority under 35 USC 119 from Japanese Patent Application No. 2025-034258 filed on March 5, 2025, the entire content of which is incorporated herein by reference.

### TECHNICAL FIELD

The present disclosure relates to a control device, a terminal device, a control method, and a non-transitory storage medium storing a control program.

### BACKGROUND ART

In recent years, efforts have been actively made to provide access to a sustainable transportation system in consideration of vulnerable people among traffic participants. In order to implement the above, focus has been placed on research and development on further improving safety and convenience of traffic by research and development related to autonomous driving techniques.

In the related art, there is known a remote parking system that remotely operates a vehicle using a smartphone to park the vehicle in a designated predetermined parking position or to move the vehicle to exit the parking position (for example, JP2021-79881A).

### SUMMARY OF INVENTION

However, in the remote parking system in the related art, it may take time to call the vehicle and cause the vehicle to exit the parking position to a predetermined position. For example, when a user operates a terminal device such as a smartphone to call a vehicle, authentication is performed, such as authenticating the vehicle being called and the terminal device, and then various devices are started, such as turning on vehicle ignition and vehicle ECU, so that the vehicle is actually moved. In such a case, the user must perform this series of operations at a calling position every time he or she calls the vehicle, which takes time to perform the operations required to call the vehicle. Therefore, the user may be irritated by the operations, and convenience of the calling function may hence be reduced.

Aspects of non-limiting embodiments of the present disclosure relates to providing a control device, a terminal device, a control method, and a non-transitory storage medium storing a control program that are capable of flexibly performing an operation of calling a moving object when moving the moving object to an exit position. This hence contributes to development of a sustainable transportation system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device for controlling a moving object capable of autonomously moving from a parking position to a predetermined exit position, the control device including a processor, the processor configured to acquire an instruction from a user for the moving object, and control the moving object based on the acquired instruction, in which the processor is capable of acquiring a reservation instruction before acquiring an exit instruction, the reservation instruction being an instruction to move the moving object, the exit instruction being an instruction to move the moving object parked at the parking position to the predetermined exit position, and the processor causes the moving object to transition to a first state in response to the processor acquiring the reservation instruction, the first state being a movement preparation state, and causes the moving object to transition from the first state to a second state in response to the processor acquiring a predetermined instruction after the reservation instruction when the moving object is in the first state, the second state being a state in which the moving object is moved.

According to an aspect of the present disclosure, there is provided a terminal device capable of executing an instruction to cause a moving object to perform autonomous movement from a parking position to a predetermined exit position, the terminal device including a processor that controls the terminal device, in which the processor acquires a reservation instruction before acquiring an exit instruction, the reservation instruction being an instruction to move the moving object, the exit instruction being an instruction to move the moving object parked at the parking position to the predetermined exit position, and gives, to the moving object that has transitioned to a first state, a predetermined instruction that causes the moving object to transition from the first state to a second state, the first state being a movement preparation state, the second state being a state in which the moving object is moved, and in which the processor gives the predetermined instruction to the moving object according to a state of the terminal device.

According to an aspect of the present disclosure, there is provided a control method for a computer to control a moving object capable of autonomously moving from a parking position to a predetermined exit position, including acquiring an instruction from a user for the moving object, controlling the moving object based on the acquired instruction, acquiring a reservation instruction before acquiring an exit instruction, the reservation instruction being an instruction to move the moving object, the exit instruction being an instruction to move the moving object parked at the parking position to the predetermined exit position, and causing the moving object to transition to a first state in response to acquiring the reservation instruction, the first state being a movement preparation state, and causing the moving object to transition from the first state to a second state in response to acquiring a predetermined instruction after the reservation instruction when the moving object is in the first state, the second state being a state in which the moving object is moved.

According to an aspect of the present disclosure, there is provided a non-transitory computer-readable storage medium storing a control program for a computer to perform processing, the computer configured to control a moving object capable of autonomously moving from a parking position to a predetermined exit position, the processing including acquiring an instruction from a user for the moving object, controlling the moving object based on the acquired instruction, acquiring a reservation instruction before acquiring an exit instruction, the reservation instruction being an instruction to move the moving object, the exit instruction being an instruction to move the moving object parked at the parking position to the predetermined exit position, and causing the moving object to transition to a first state in response to acquiring the reservation instruction, the first state being a movement preparation state, and causing the moving object to transition from the first state to a second state in response to acquiring a predetermined instruction after the reservation instruction when the moving object is in the first state, the second state being a state in which the moving object is moved.

According to the present disclosure, it is possible to flexibly perform an operation of calling a moving object when moving the moving object to an exit position.

### BRIEF DESCRIPTION OF DRAWINGS

Exemplary embodiment(s) of the present invention will be described in detail based on the following figures, wherein:

FIG. 1 is a side view illustrating an example of a vehicle 10 equipped with a control device 20;

FIG. 2 is a top view of the vehicle 10;

FIG. 3 is a block diagram illustrating an example of an internal configuration of the vehicle 10;

FIG. 4 is a diagram illustrating an example of a disclaimer screen displayed on a touch panel 42;

FIG. 5 is a diagram illustrating an example of a screen for accepting a reservation instruction displayed on the touch panel 42;

FIG. 6 is a diagram illustrating a screen for accepting a setting of an exit position and a setting of a route in the reservation instruction;

FIG. 7 is a diagram illustrating an example of a hardware configuration of a terminal device 60 owned by a user of the vehicle 10;

FIG. 8 is a diagram illustrating an example of giving a vehicle start instruction based on position information of the terminal device 60;

FIG. 9 is a diagram illustrating an example of a response request screen for the vehicle start instruction displayed on the terminal device 60;

FIG. 10 is a diagram illustrating an example of a response request screen for an exit instruction displayed on the terminal device 60;

FIG. 11 is a flowchart illustrating an example of processing executed by the vehicle 10;

FIG. 12 is a diagram illustrating a subroutine of step S1 in the flowchart of FIG. 11;

FIG. 13 is a flowchart illustrating an example of processing executed by the terminal device 60; and

FIG. 14 is a flowchart illustrating another example of the processing executed by the terminal device 60.

### DESCRIPTION OF EMBODIMENTS

Hereinafter, an embodiment will be described with reference to the accompanying drawings. The following embodiment does not limit the present invention, and not all of elements described in the following embodiment are necessary to the present invention. Two or more elements described in the following embodiment may be freely combined without departing from the gist of the present invention. Note that in the following, the same or similar elements are denoted by the same or similar reference numerals, and a description thereof may be omitted or simplified.

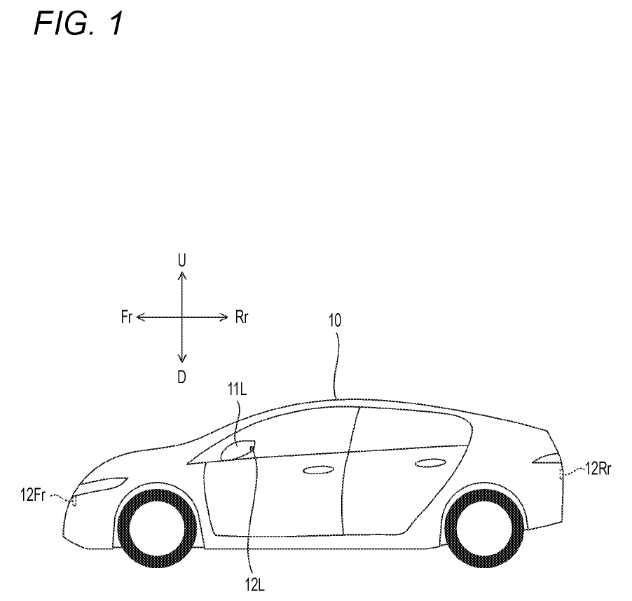

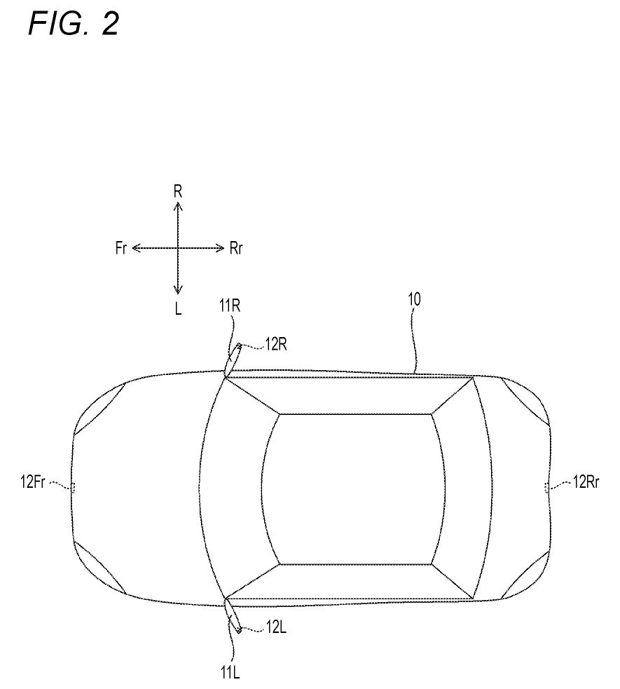

Note that the drawings are viewed in directions of reference numerals. In order to simplify and clarify the description in the present specification or the like, a front-rear direction, a left-right direction, and an upper-lower direction are described according to directions viewed from a driver of the vehicle 10 illustrated in FIGS. 1 and 2.

In the drawings, a front side of the vehicle 10 is shown as "Fr", a rear side is shown as "Rr", a left side is shown as "L", a right side is shown as "R", an upper side is shown as "U", and a lower side is shown as "D".

### Overall Configuration

In the embodiment, it is possible to flexibly perform an operation when causing a vehicle 10 capable of autonomously moving from a predetermined parking position in a parking lot to a predetermined exit position to exit. In the embodiment, constituent elements for achieving such a configuration include the vehicle 10 and a terminal device 60, which cooperate with each other. Configurations and processing of the vehicle 10 and the terminal device 60 will be described below.

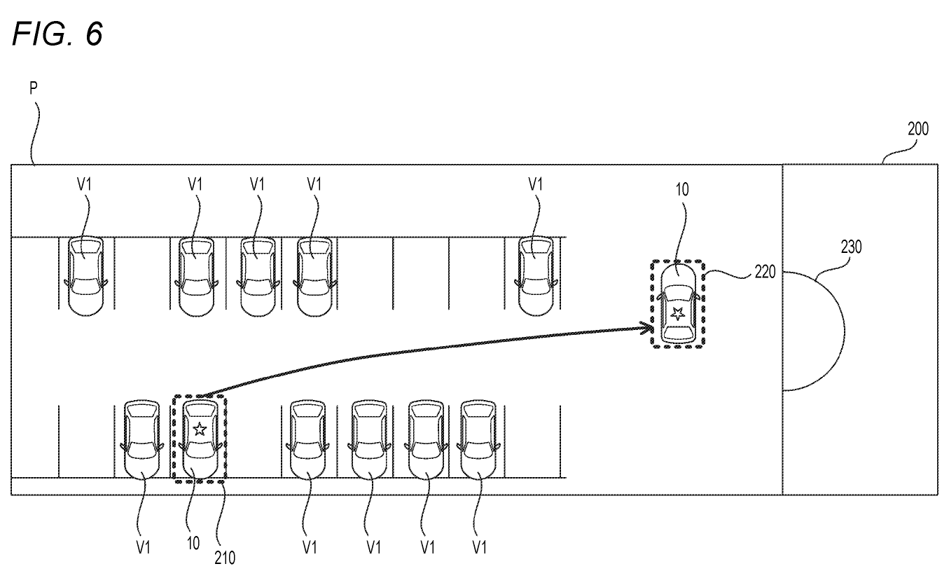

Note that the parking lot is a space having a plurality of parking positions (parking frames), and is assumed as a parking lot in a commercial facility such as a shopping mall, or a parking space at an event site or the like. In the embodiment, for example, as illustrated in FIG. 6, an example is shown in which a vehicle 10 parked in a predetermined parking position 210 in a parking lot P provided adjacent to a commercial facility 200 is autonomously moved to a predetermined exit position 220.

Note that the exit position 220 may be determined in advance by the commercial facility 200, or may be designated by a user, for example. In the embodiment, the exit position 220 is provided to be near an entrance 230 of the commercial facility 200. In FIG. 6, the reference numeral V1 indicates another vehicle during parking at a position different from the parking position 210.

### Configuration of Vehicle Equipped with Control Device

FIG. 1 is a side view illustrating an example of the vehicle 10 equipped with a control device 20. FIG. 2 is a top view of the vehicle 10 illustrated in FIG. 1. The vehicle 10 is an example of a "moving object" in the embodiment.

The vehicle 10 is an automobile including a drive source (not illustrated) and wheels including drive wheels driven by power of the drive source and steerable steered wheels. In the embodiment, the vehicle 10 is a four-wheeled automobile including a pair of left and right front wheels and a pair of left and right rear wheels. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 is capable of driving assistance. The driving assistance defined here means that a system of the vehicle 10 performs at least a part of recognition or monitoring of a travel environment and a surrounding situation, as well as driving operations such as starting, accelerating and decelerating, steering, and stopping. In the embodiment, driving assistance is possible at least for parking. For example, parking assistance of automatically controlling (automatically steering) the driving operations when parking the vehicle 10, and exiting assistance of moving the vehicle 10 from the parking position 210 to the predetermined exit position 220 are possible. Note that the vehicle 10 may be a vehicle capable of automatic driving in which the system of the vehicle 10 performs all of recognition or monitoring of a travel environment and a surrounding situation, as well as driving operations such as starting, accelerating and decelerating, steering, and stopping.

The vehicle 10 further includes side mirrors 11L and 11R. The side mirrors 11L and 11R are mirrors (back mirrors) provided on outer sides of front seat doors of the vehicle 10 for a driver to check a rear side and rear lateral sides. The side mirrors 11L and 11R are fixed to a body of the vehicle 10 by rotation shafts extending in a vertical direction, respectively, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

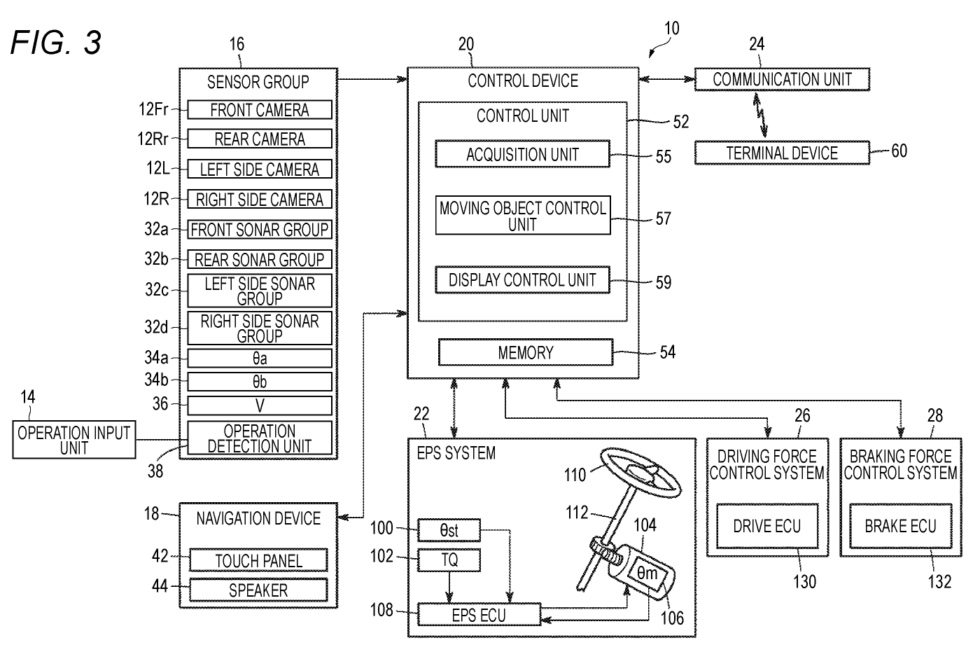

FIG. 3 is a block diagram illustrating an example of an internal configuration of the vehicle 10 illustrated in FIG. 1. As illustrated in FIG. 3, the vehicle 10 includes a sensor group 16, a navigation device 18, the control device 20, an electric power steering (EPS) system 22, and a communication unit 24. The vehicle 10 further includes a driving force control system 26 and a braking force control system 28.

The sensor group 16 acquires various detection values used for control by the control device 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire external environment recognition data (for example, peripheral images) for recognizing an external environment of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34aand 34bmay be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control device 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control device 20. The operation input unit 14 includes various user interfaces such as a side mirror switch that switches the side mirrors 11L and 11R between opened and closed states, and a shift device (for example, a shift lever or a shift switch).

The navigation device 18 detects a current position of the vehicle 10 using, for example, a GNSS receiver (not illustrated). The GNSS receiver identifies the current position of the vehicle 10 (for example, latitude and longitude of a location where the vehicle 10 is at) based on signals received from GNSS satellites. Note that the navigation device 18 may acquire detection results of the wheel sensor 34a, the wheel sensor 34b, and the vehicle speed sensor 36 via the control device 20, and identify or complement the current position of the vehicle 10 by an inertial navigation system (INS) using the detection values of these sensors.

The navigation device 18 also includes a touch panel 42 and a speaker 44. The touch panel 42 functions as an input device and a display device of the control device 20. The speaker 44 outputs various types of guidance information to the user of the vehicle 10 by voice.

The touch panel 42 functions as an input device that receives inputs of various types of information for the control device 20 and as a display device controlled by the control device 20. For example, the touch panel 42 is implemented by combining a display device such as a liquid crystal display or an organic light emitting diode (OLED) with a pointing device (for example, a touch pad). The speaker 44 is configured to output sound to an occupant of the vehicle 10. Note that the touch panel 42 is an example of a "display" in the embodiment.

For example, the user may input a command related to movement assistance of the vehicle 10 via the touch panel 42. The movement assistance includes parking assistance and exiting assistance of the vehicle 10. The touch panel 42 is configured to display various screens related to control contents of the control device 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a remote parking button for requesting parking by automatic steering of the control device 20, and a parking support button for requesting support when parking by an operation of the user. The exiting assistance button includes a remote exiting button for requesting exiting by automatic steering of the control device 20, and an exiting support button for requesting support when exiting by an operation of the user. Note that a constituent element other than the touch panel 42, for example, a terminal device such as a smartphone or a tablet may be used as the input device or the display device.

For example, the "parking" is a stop as the occupant gets on or off the vehicle, and excludes a temporary stop due to a traffic signal or the like. The "parking position" means a position where the vehicle 10 is to be stopped, that is, a position to be parked at.

The control device 20 is, for example, a computer that controls the entire vehicle 10 and includes a control unit 52 that performs various calculations, a memory 54 that has a non-transitory storage medium that stores various types of information, an input and output unit (not illustrated) that inputs and outputs signals between each units connected to the control device 20, and the like.

The control device 20 is implemented by one electronic control unit (ECU) or by a plurality of ECUs working together. Note that the control device 20 performs movement assistance such as controlling the vehicle on behalf of the user, and can therefore be said as a control device in a so-called advanced driving assistance system. A specific configuration and a specific control example of the control device 20 including the control unit 52 and the memory 54 will be described below, and therefore, description thereof will be omitted here.

The communication unit 24 is a communication interface that communicates with an external device according to a control instruction from the control device 20. That is, the control device 20 may communicate with the external device via the communication unit 24. Examples of the external device include the terminal device 60 such as a smartphone or a tablet that can be carried by the user, and a server device managed by a manufacturer of the vehicle 10. For example, a mobile communication network such as a cellular line, WI-FI (registered trademark), or Bluetooth (registered trademark) can be used for the communication between the vehicle 10 and the external device.

The EPS system 22 includes, for example, a steering angle sensor 100, a torque sensor 102, an EPS motor 104, a resolver 106, and an EPS_ECU 108.

The steering angle sensor 100 detects a steering angle θst of a steering 110 and outputs information indicating the detected steering angle θst to the EPS_ECU 108. The torque sensor 102 detects a steering torque TQ, which is a torque applied to the steering 110 of the vehicle 10, and outputs information indicating the detected steering torque TQ to the EPS_ECU 108.

The EPS motor 104 assists the driver in operating the steering 110 by applying, according to an instruction from the EPS_ECU 108, a driving force or a reaction force to a steering column 112 coupled to the steering 110. The resolver 106 detects a rotation angle θm of the EPS motor 104 and outputs information indicating the detected rotation angle θm to the EPS_ECU 108.

The EPS_ECU 108 controls the entire EPS system 22. The EPS_ECU 108 is a computer that controls the EPS system 22 and includes a processor that performs various calculations, a memory that has a non-transitory storage medium for storing various types of information, an input and output unit that controls input and output of data between inside and outside of the EPS_ECU 108 (all not illustrated), and the like, and is implemented by one or more ECUs.

The driving force control system 26 includes a drive ECU 130, and is configured to control the driving force of the vehicle 10. The drive ECU 130 is, for example, a computer that controls the driving force control system 26 and includes a processor that performs various calculations, a memory having a non-transitory storage medium that stores various types of information, an input and output unit that controls input and output of data between inside and outside of the drive ECU 130 (all not illustrated), and the like, and is implemented by one or more ECUs. For example, the drive ECU 130 controls the driving force of the vehicle 10 by controlling the internal combustion engine and the like, based on an amount of operation on an accelerator pedal (not illustrated) provided on the vehicle 10 and a detection value of a shift position sensor (not illustrated) that detects a shift position of the shift device (such as a shift lever or a shift switch), which is not illustrated.

The braking force control system 28 includes a brake ECU 132 and is configured to control a braking force of the vehicle 10. The brake ECU 132 is, for example, a computer that controls the braking force control system 28 and includes a processor that performs various calculations, a memory having a non-transitory storage medium for storing various types of information, an input and output unit for controlling input and output of data between inside and outside of the brake ECU 132 (all not illustrated), and the like, and is implemented by one or more ECUs. For example, the brake ECU 132 controls the braking force of the vehicle 10 by controlling a brake device (not illustrated) provided in the vehicle 10 based on an operation on a brake pedal (not illustrated) provided in the vehicle 10.

### Configuration of Control Device

Next, the configuration of the control device 20 will be described. The control device 20 includes the control unit 52 and the memory 54 as described above. The memory 54 stores various types of data and programs to be executed by the control unit 52.

For example, the memory 54 stores map information. The map information includes node data indicating positions of nodes set on roads, link data indicating links between nodes, and facility data indicating positions of facilities on and around the roads. Note that the facility data also includes information on in-facility roads, such as in-parking lot roads, which are roads within the parking lot P. Therefore, by referring to the map information, the control device 20 can display on the touch panel 42 not only the map of the roads but also the in-parking lot roads.

The memory 54 also stores information related to remote movement of the vehicle 10. The memory 54 stores, for example, route information related to a movement route when the vehicle 10 moves from an entry start position to a stop position. The stop position refers to a parking position of the vehicle 10, and will hereinafter be referred to as a parking position. Moving to the parking position means moving to the parking position by the user’s driving or by the movement assistance. The entry start position refers to a position of the vehicle 10 when the user starts parking, and includes, for example, a position of the vehicle 10 when the user presses the parking assistance button to activate a parking assistance function, a position of the vehicle 10 when the vehicle 10 enters a predetermined parking lot region, and a position of the vehicle 10 when the vehicle 10 arrives at the vicinity of a destination indicated by the navigation device 18. The route information includes route data indicating the movement route, parking position data indicating the parking position, and peripheral environment data indicating a feature of a peripheral environment of the movement route and the parking position based on the external environment recognition data.

Note that such map information and route information may be stored in the storage medium in the navigation device 18.

The control unit 52 executes various programs stored in the memory 54. In the embodiment, the control unit 52 executes processing that enables a flexible operation of calling the vehicle 10 when moving the vehicle 10 to the exit position 220. When remote exiting is performed, it is assumed that the user calls the vehicle 10 by operating the terminal device 60 such as a smartphone, for example. For example, it can be assumed that various authentications are performed, such as an authentication between the vehicle 10 being called and the terminal device 60, and then various devices and the like are started, such as turning on an ignition of the vehicle 10 and each ECU of the vehicle 10, so as to actually move the vehicle 10. In such a case, the user needs to perform this series of operations at a calling position every time the user calls the vehicle 10, and the operations required to call the vehicle 10 take time. Therefore, the user may be irritated by the operations, and convenience of the calling function may hence be reduced. Therefore, the embodiment has a configuration in which a predetermined program is executed that enables a flexible operation of calling the vehicle 10.

The control unit 52 includes an acquisition unit 55, a moving object control unit 57, and a display control unit 59 as functional units implemented by executing the predetermined program. Note that in the following description, processing described as being performed by the acquisition unit 55, the moving object control unit 57, and the display control unit 59 are processing that is implemented by the control device 20 (control unit 52).

The acquisition unit 55 acquires instructions from the user for the vehicle 10. Specifically, the acquisition unit 55 acquires a "reservation instruction", a "vehicle start instruction", and an "exit instruction". Note that the vehicle start instruction is an example of a "predetermined instruction" in the embodiment.

Specifically, first, the acquisition unit 55 acquires the reservation instruction for moving the vehicle 10 before acquiring from the user the exit instruction for remote exiting in which the vehicle 10 parked at the parking position 210 is moved to the exit position 220. As described above, in remote exiting, the series of operations for calling the vehicle 10 takes time. Therefore, in the embodiment, some operations are configured to be received in advance as the "reservation instruction". Some of the operations are, for example, operations that should be performed before starting each device, such as the ignition of the vehicle 10, the control device 20, the EPS_ECU 108, the drive ECU 130, and the brake ECU 132, that sets the vehicle 10 to a movable state.

Examples of such operations include an authentication operation between the terminal device 60 and the vehicle 10, an agreement operation of receiving an agreement to a disclaimer, and a setting operation for setting the exit position 220. Note that the agreement operation of receiving the agreement to the disclaimer here refers to an operation of receiving an agreement to a precaution stipulated for the movement assistance. In the embodiment, such an operation related to the "reservation instruction" is received, for example, on the touch panel 42 of the navigation device 18 of the vehicle 10, or received by coordination between the touch panel 42 and the terminal device 60. In the embodiment, the display control unit 59 functions to display predetermined information on the touch panel 42 and receive input from the user.

Specifically, during the authentication operation between the terminal device 60 and the vehicle 10, the display control unit 59 displays a predetermined operation screen related to the authentication operation on the touch panel 42. The authentication operation may be implemented by, for example, comparing digital keys between the vehicle 10 and the terminal device 60. Note that if there are a plurality of vehicles that can be targeted, the user selects the vehicle to be subjected to the remote exiting and then performs the authentication operation.

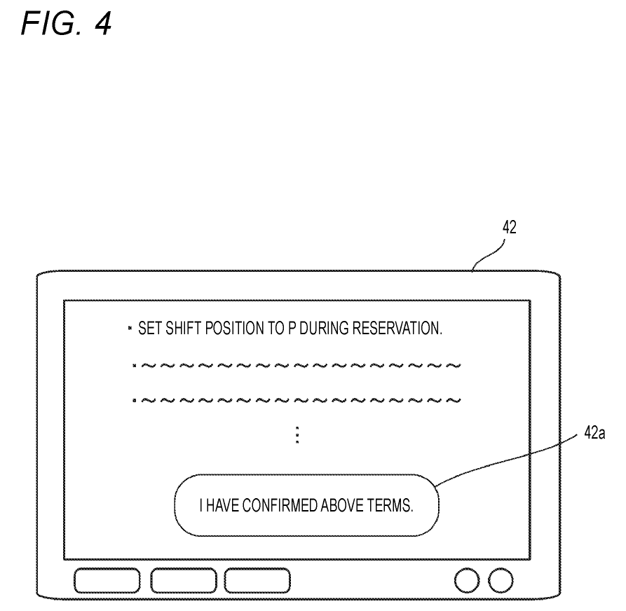

In the agreement operation of receiving the agreement to the disclaimer, the display control unit 59 causes the touch panel 42 to display a disclaimer screen for receiving the agreement to the disclaimer. FIG. 4 is a diagram illustrating an example of the disclaimer screen for receiving the agreement to the disclaimer, in which an agreement sentence such as "WHEN MAKING RESERVATION, SET SHIFT POSITION TO P RANGE" is shown. The disclaimer screen also includes an agreement button 42a to be operated by the user to indicate that the user has confirmed the precaution.

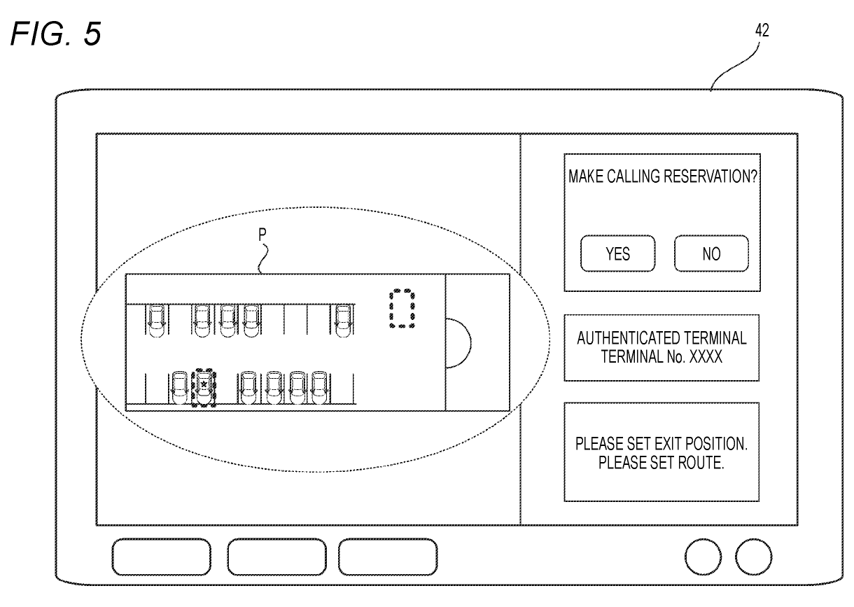

The display control unit 59 receives from the user the setting on the position to which the vehicle 10 is caused to exit in the setting operation for the exit position 220. FIG. 5 is an example of a screen displayed on the touch panel 42 that receives the reservation instruction, including receiving the setting on the exit position 220 from the user. Here, for example, a parking lot map is displayed on a left side of the screen, and an explanatory note urging the user to set the exit position 220, a route, and the like is displayed on a right side of the screen. On the right side of the screen, a display for confirming whether to give the reservation instruction, a terminal number of the terminal device 60 authenticated by the authentication operation with the terminal device 60, and the like are also displayed. Note that the various types of information shown here are not necessarily displayed on one screen, but may instead be displayed on different screens for each setting, for example.

FIG. 6 is an enlarged view of the parking lot map part enclosed by a dashed line on the screen displayed in FIG. 5. The display control unit 59 displays, for example, a parking lot map of the parking lot P where the vehicle 10 is currently parked on the touch panel 42, and receives a setting on a predetermined exit position from the user. The user can set the exit position by, for example, tapping on the touch panel 42. In the example illustrated in FIG. 6, for example, the user designates the place surrounded by a thick dashed line indicated by reference numeral 220 as the exit position.

It is preferable that the display control unit 59 receives a setting on a route from the parking position 210 to the exit position 220 along with the setting on the exit position 220. For example, the display control unit 59 displays the parking lot map on the touch panel 42, and receives from the user the setting on the route to the exit position 220. The user sets the route by, for example, tracing an approximate route with a finger. In the example illustrated in FIG. 6, for example, a route designated by the user from the parking position 210 to the exit position 220 is indicated by an arrow.

Note that if there has been a parking history at the current parking position 210 and information on the parking history is stored in the memory 54, the display control unit 59 may refer to the memory 54 to identify the relevant parking history and display information on a route including a start position and an end position of parking on the touch panel 42 based on the parking lot map. When the user wants to cause the vehicle 10 to exit to the same exit position 220 along the same route as the displayed information on the parking history, the user designates the end position as the exit position 220 on the displayed parking lot map. In this way, the display control unit 59 can receive the designated end position as the exit position 220.

After receiving all of these operations related to the reservation instruction, the display control unit 59 displays a message indicating that the reservation instruction is completed, such as "RESERVATION COMPLETED".

The vehicle start instruction is an instruction for setting the vehicle 10 to a movable state, and includes instructions to start the ignition of the vehicle 10, the control device 20, each ECU such as the EPS_ECU 108, the drive ECU 130, and the brake ECU 132 (hereinafter simply referred to as each ECU), as well as each device (for example, a driving battery) for driving the vehicle 10. This vehicle start instruction can be acquired after the reservation instruction, and is given according to a use state such as position information and payment information of the terminal device 60 carried by the user, for example. The acquisition unit 55 acquires the instruction via the communication unit 24. Detailed description of the configuration of the terminal device 60 will be given below.

The exit instruction is an instruction for causing the vehicle 10 to perform remote exiting, and is given by the user operating the terminal device 60, and the acquisition unit 55 acquires the instruction via the communication unit 24.

The moving object control unit 57 controls the state of the vehicle 10 based on the instructions from the user acquired by the function of the acquisition unit 55. For example, when the acquisition unit 55 acquires the above reservation instruction, the moving object control unit 57 causes the vehicle 10 to transition to a first state, which is a movement preparation state. The first state (movement preparation state) is, for example, a state in which the ignition is turned off, the control devices such as each ECU of the vehicle 10 are not started, and communication with the terminal device 60 is possible. In other words, the vehicle 10 appears to be simply parked in the parking lot P, but the vehicle 10 is actually in a state of being capable of communicating with the terminal device 60.

When the state of the vehicle 10 is in the first state and the acquisition unit 55 has acquired the vehicle start instruction after the reservation instruction, the moving object control unit 57 causes the state of the vehicle 10 to transition from the first state to a second state in which the vehicle 10 is moved according to the exit instruction. That is, when the vehicle start instruction is acquired after the reservation instruction, the moving object control unit 57 causes the vehicle 10 to transition to the second state of being movable. Then, when the user gives the exit instruction, remote exiting of calling the vehicle 10 to the exit position 220 is performed. Note that the second state is a state in which the vehicle 10 is movable, and therefore the ignition, control devices such as each ECU, and other devices necessary to drive the vehicle 10 (for example, the driving battery and the like) are started.

After the acquisition unit 55 functions to acquire the exit instruction, the moving object control unit 57 performs driving control, braking control, steering control, and the like via the drive ECU 130, the brake ECU 132, the EPS_ECU 108, and the like, to perform remote exiting from the parking position 210 to the exit position 220 designated by the user.

### Configuration of Terminal Device

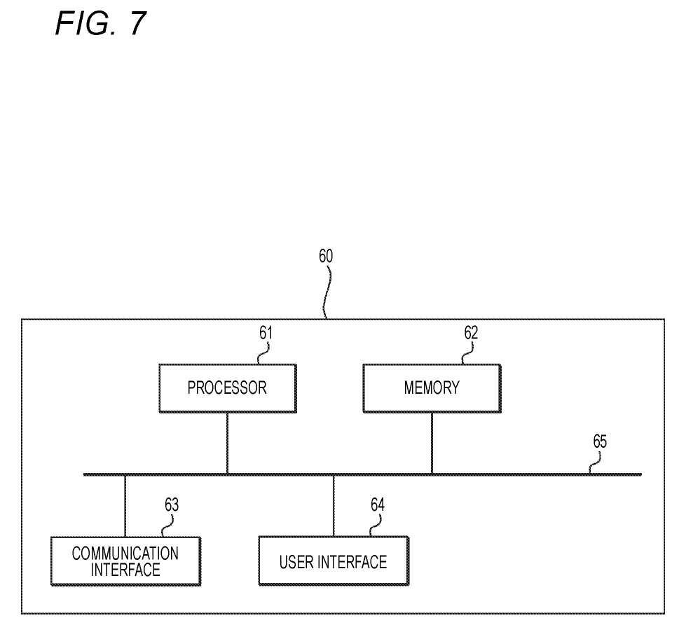

Next, the configuration of the terminal device 60 will be described. FIG. 7 is a diagram illustrating an example of a hardware configuration of the terminal device 60 owned by the user of the vehicle 10. Here, the terminal device 60 is assumed to be a smartphone as an example. The terminal device 60 includes a processor 61, a memory 62, a communication interface 63, and a user interface 64. The processor 61, the memory 62, the communication interface 63, and the user interface 64 are connected by, for example, a bus 65.

The processor 61 is a circuit that executes signal processing, and is, for example, a central processing unit (CPU) that controls the entire terminal device 60. Note that the processor 61 may be implemented by another digital circuit such as a field programmable gate array (FPGA) or a digital signal processor (DSP). The processor 61 may also be implemented by combining a plurality of digital circuits. Note that the processor 61 is an example of a "control unit of the terminal device 60".

The memory 62 includes, for example, a main memory and an auxiliary memory. The main memory is, for example, a random access memory (RAM). The main memory is used as a work area of the processor 61.

The auxiliary memory is, for example, a non-volatile memory such as a magnetic disk, an optical disk, or a flash memory. Various programs for operating the terminal device 60 are stored in the auxiliary memory. The programs stored in the auxiliary memory are loaded into the main memory and executed by the processor 61.

The auxiliary memory may include a portable memory removable from the terminal device 60. Examples of the portable memory include a universal serial bus (USB) flash drive, a memory card such as a secure digital (SD) memory card, and an external hard disk drive.

The communication interface 63 is a communication interface that executes wireless communication with the outside of the terminal device 60 (for example, the communication unit 24 of the vehicle 10). For example, the communication interface 63 includes an interface for executing communication with the vehicle 10.

The user interface 64 includes, for example, an input device that receives an operation input from the user and an output device that outputs information to the user. The input device may be implemented by, for example, a touch panel. The output device may be implemented by, for example, a display or a speaker.

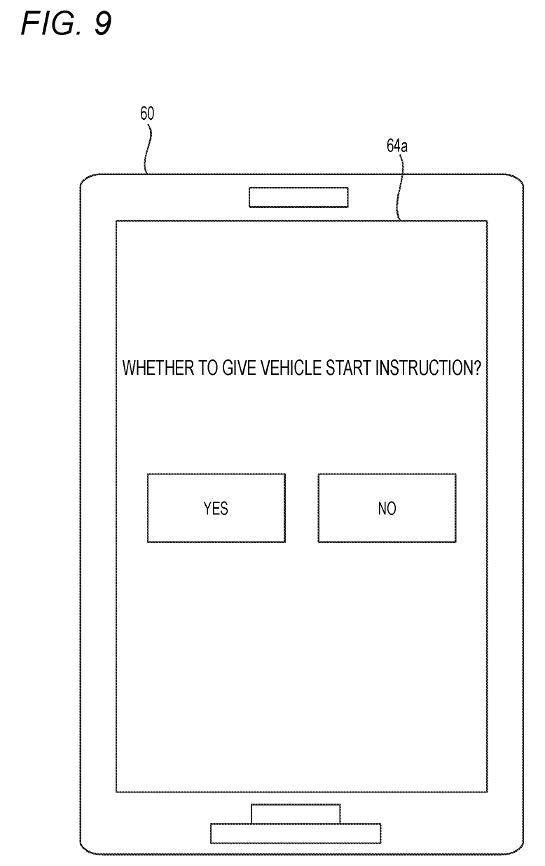

The processor 61 executes movement control for instructing movement of the vehicle 10. For example, the processor 61 performs the movement control (for example, exiting control) on the vehicle 10 based on a specific operation of the user on a terminal screen 64a (for example, see FIG. 9) of the terminal device 60. The specific operation includes, for example, a tap operation for giving an instruction related to exiting (calling) of the vehicle 10, and a slide operation for moving the vehicle 10. The slide operation includes a continuous position instruction operation (for example, a swiping operation), a rotation instruction operation in a predetermined rotation direction (for example, rotation swiping operation), and the like. The processor 61 performs control of generating a guidance image for urging the user to perform an instruction operation on the terminal screen 64a of the terminal device 60 and displaying the generated guidance image on the terminal screen 64a.

Based on the specific operation on the terminal screen 64a of the terminal device 60, the processor 61 gives the vehicle start instruction or the exit instruction to the vehicle 10 for causing the vehicle 10 to perform remote exiting. That is, the vehicle start instruction and the exit instruction are given to the vehicle 10 via the communication interface 63.

Specifically, the processor 61 gives the vehicle start instruction for setting the vehicle 10 to a movable state (in other words, a state in which remote exiting is possible) depending on the use state of the terminal device 60. Here, the use state of the terminal device 60 includes, for example, use of the terminal device 60 accompanying the movement of the user, or use of the terminal device 60 based on payment processing of the user.

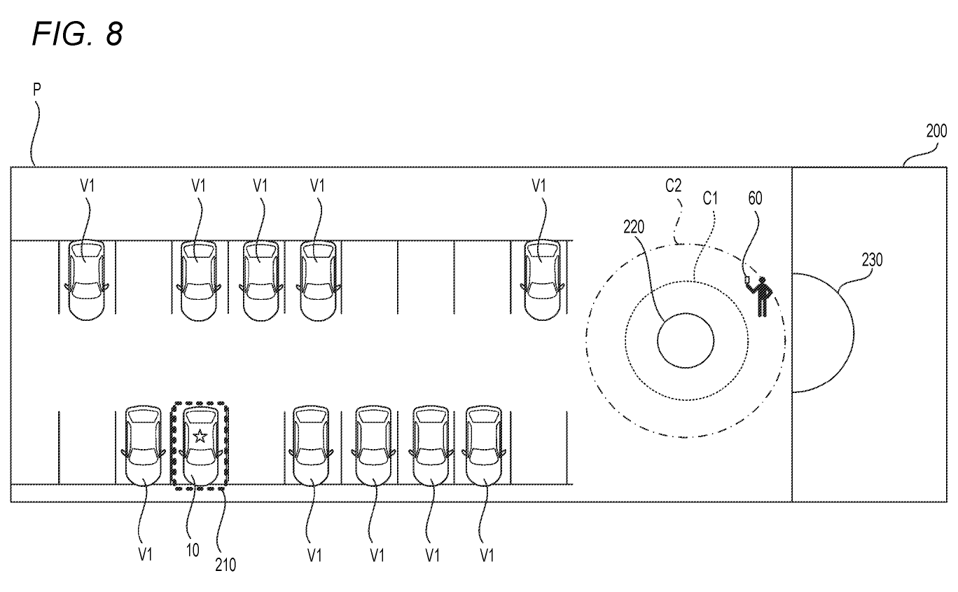

For example, the processor 61 acquires the position information of the terminal device 60. Then, based on the acquired position information, if the position of the terminal device 60 is outside a first range C1 and within a second range C2 from the exit position 220, a response request is made to the user for giving the vehicle start instruction. FIG. 8 is a diagram illustrating an example of giving the vehicle start instruction based on position information of the terminal device 60. In the example illustrated in FIG. 8, a range surrounded by a solid line indicates a range of the exit position 220, a range surrounded by a dashed line indicates the first range C1, and a range surrounded by an alternate long and short dash line indicates the second range C2. That is, in the example illustrated here, when the position of the terminal device 60 is between the first range C1 and the second range C2, the processor 61 executes a response request to the user for giving the vehicle start instruction. In the example illustrated in FIG. 8, the terminal device 60 is positioned between the first range C1 and the second range C2 as the user moves.

In such a case, the processor 61 displays, on the terminal screen 64a, the response request inquiring "WHETHER TO GIVE VEHICLE START INSTRUCTION" as illustrated in FIG. 9 for example. Then, after a positive response instruction to the response request is received from the user, the processor 61 gives the vehicle start instruction to the vehicle 10. Note that if the user currently does not desire remote exiting, it can be assumed that the user will give a negative response instruction to the response request, or will not respond at all.

If the acquired position information indicates that the position of the terminal device 60 is within the first range C1 from the exit position 220, the processor 61 may give the vehicle start instruction to the vehicle 10 without executing the response request as illustrated in FIG. 9. In other words, when the terminal device 60 is positioned within the first range C1, the terminal device 60 is at a place closer to the exit position 220 than the area enclosed by the first range C1 and the second range C2, and therefore, it can be assumed that the user is requesting remote exiting. Therefore, in such a case, it is assumed that the vehicle start instruction has been given, and the vehicle start instruction is given without executing the response request.

Note that the first range and the second range may be ranges that are predetermined by, for example, the manufacturer.

The vehicle start instruction may be given by using the terminal device 60 based on the payment processing of the user, in addition to the use state of the terminal device 60 based on the position information. For example, the processor 61 acquires the payment information of the user. The payment information is, for example, payment information such as credit card payment using the terminal device 60 or payment by electronic money. Once the payment information is acquired, the processor 61 executes the response request to the user for giving the vehicle start instruction. The response request may be the same as the example illustrated in FIG. 9. Then, after a positive response instruction to the response request is received from the user, the processor 61 gives the vehicle start instruction to the vehicle 10.

Note that after acquiring the payment information, the processor 61 may give the vehicle start instruction to the vehicle 10 without executing the response request. In this case, it is assumed that the user requests the remote exiting since the payment processing has been performed. The processor 61 may distinguish between giving the vehicle start instruction after making the response request and giving the vehicle start instruction without making the response request, depending on a content of the payment information. For example, if the payment information satisfies a predetermined condition, the processor 61 gives the vehicle start instruction without executing the response request. The predetermined condition may be that, for example, if the payment processing has been performed for a plurality of times (for example, two or more times), the vehicle start instruction may be given without executing the response request. Some users may make a plurality of times of payment within a facility, such as paying for items on different floors or forgetting to buy something, and therefore, when the payment processing is performed for a plurality of times, the possibility of such an event occurring is low. In other words, if the payment processing has been performed only once, there is a possibility that the payment processing may be performed again, and in that case, the vehicle start instruction is given after the response request is made.

The processor 61 gives the vehicle start instruction to set the vehicle 10 to a movable state according to such a use state. Note that in addition to the examples described above, the use state may also include, for example, a use when the user manually calls the vehicle 10, or a use coordinated with a schedule table stored in the terminal device 60. The use when the user manually calls the vehicle 10 means that the user gives the vehicle start instruction to the vehicle 10 at his or her own timing. The use coordinated with the schedule table function stored in the terminal device 60 means that if the user has previously input a schedule for performing remote exiting on the vehicle 10 to a schedule table such as a calendar in the terminal device 60, the vehicle start instruction is automatically given coordinated with that timing.

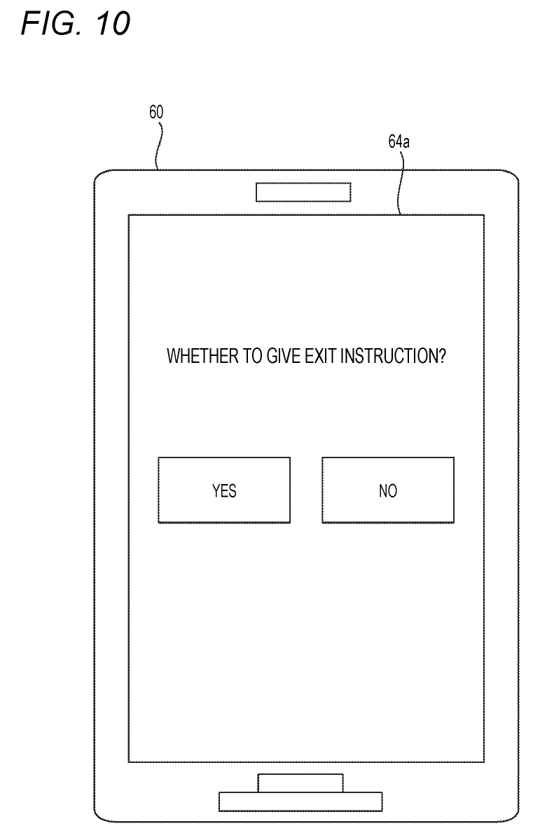

After giving the vehicle start instruction, the processor 61 gives the exit instruction. That is, the processor 61 transmits to the vehicle 10 the exit instruction for causing the vehicle 10 to perform remote exiting based on a specific operation on the terminal screen 64a of the terminal device 60. FIG. 10 illustrates the terminal screen 64a showing an example of a response request for the exit instruction. The user can give the exit instruction by responding to this response request.

Note that an application configured to perform movement control (remote parking, remote exiting) on the vehicle 10 by transmitting and receiving information related to the movement control of the vehicle 10 to and from the vehicle 10 may be installed in the terminal device 60.

### Example of Processing in Embodiment

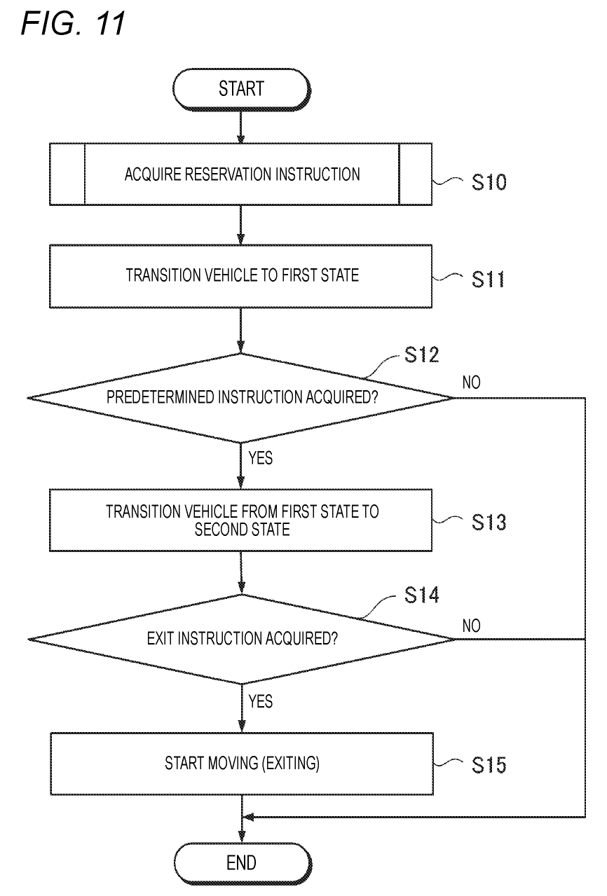

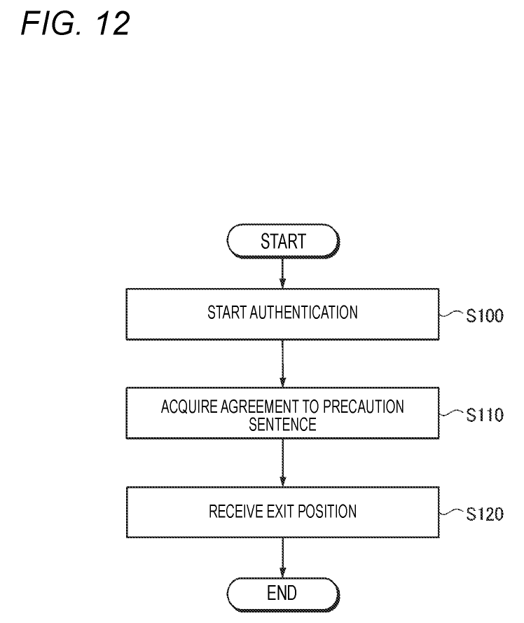

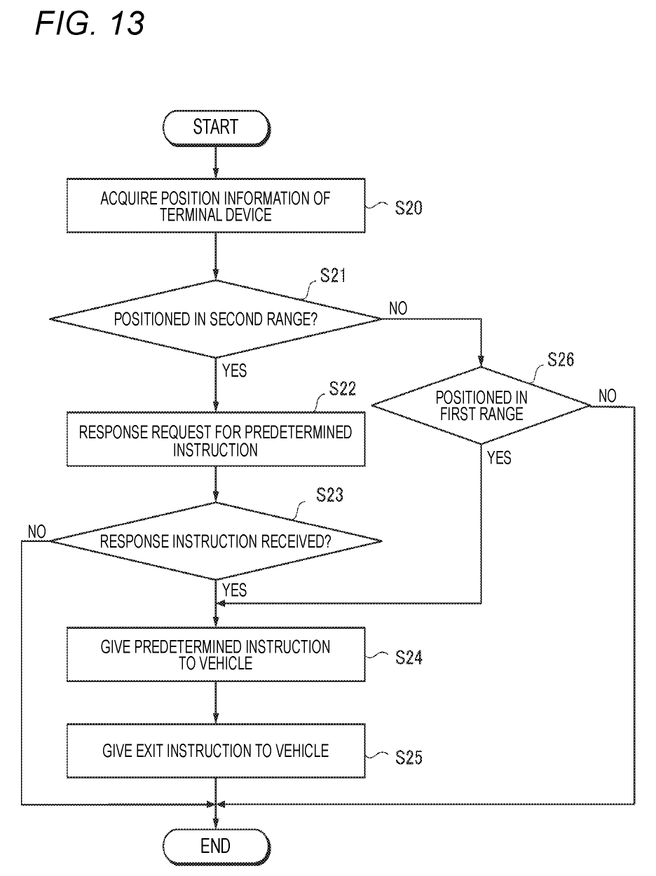

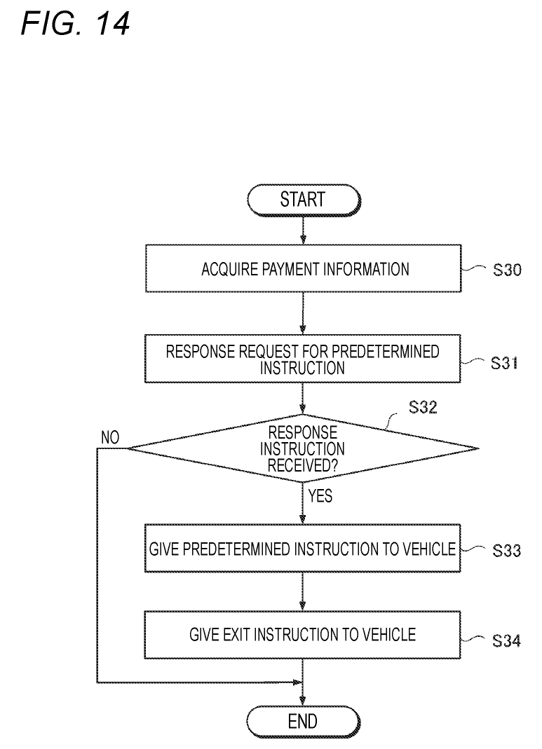

Next, an example of processing in the embodiment will be described. As described above, the vehicle 10 and the terminal device 60 can communicate with each other and cooperate with each other. FIGS. 11 to 14 are flowcharts showing the example of processing in the embodiment, in which FIGS. 11 and 12 show processing in the control device 20 of the vehicle 10, and FIGS. 13 and 14 show processing in the processor 61 of the terminal device 60. Here, the processing in the control device 20 will be described first.

As described above, when the remote exiting is performed, the control device 20 sequentially acquires the reservation instruction and the vehicle start instruction, and causes the transition of the state of the vehicle 10 according to each instruction. Then, when the exit instruction is acquired, movement of the vehicle 10 is started. Here, a flow of this processing will be described using the flowchart shown in FIG. 11. Note that since the specific content of the processing executed by the control device 20 is as described above, here, the flow of the processing will be mainly described, and the detailed description of the processing will be omitted or simplified.

Note that in the example shown here, it is assumed that the vehicle 10 is in a state of being parked at the predetermined parking position 210, and that the user operates the remote exiting button or the like under that state.

First, the control device 20 acquires the reservation instruction (step S10). That is, the control device 20 causes the touch panel 42 to display a screen for receiving operations of the reservation instruction. FIG. 12 shows a subroutine for acquiring the reservation instruction, in which the above-mentioned operations of the reservation instruction are sequentially received.

Specifically, in step S100, the control device 20 receives an authentication operation between the terminal device 60 and the vehicle 10.

In step S110, the control device 20 receives an agreement operation for receiving an agreement to the disclaimer, as described with reference to FIG. 4.

In step S120, the control device 20 also receives the operations of setting the exit position 220 and setting the route, as described with reference to FIG. 6.

After the control device 20 receives all of these operations related to the reservation instruction, the processing of acquiring the reservation instruction is ended.

Returning to FIG. 11, the control device 20 causes the state of the vehicle 10 to transition to the first state (step S11). That is, after acquiring the reservation instruction by step S10, the control device 20 causes the state of the vehicle 10 to transition to the first state in which communication with the terminal device 60 of the user is possible from outside the vehicle. Note that in the first state, as described above, the ignition and each ECU of the vehicle 10 are turned off.

Next, the control device 20 determines whether the vehicle start instruction has been received (step S12). That is, the control device 20 determines whether the vehicle start instruction has been received from the terminal device 60 of the user. For example, the vehicle start instruction is obtained based on the position information and the payment information of the terminal device 60.

If it is determined in step S12 that the vehicle start instruction has not been acquired (No in step S12), the control device 20 waits until the vehicle start instruction is acquired. Note that a waiting time may be set in advance. In this case, for example, after the waiting time has elapsed, the processing shown in FIG. 11 is temporarily ended. In this case, for example, the reservation instruction may be regarded as having been temporarily canceled.

On the other hand, if it is determined that the vehicle start instruction has been acquired (Yes in step S12), the control device 20 proceeds to step S13. In step S13, the control device 20 causes the state of the vehicle 10 to transition from the first state to the second state. That is, the ignition and each ECU of the vehicle 10 are turned on to set the vehicle 10 to a movable state.

Next, the control device 20 determines whether the exit instruction has been acquired (step S14). That is, the control device 20 determines whether the exit instruction has been received from the terminal device 60 of the user.

If it is determined in step S14 that the exit instruction has not been acquired (No in step S14), the control device 20 waits until the exit instruction is acquired. Note that a waiting time may be set in advance. In this case, for example, after the waiting time has elapsed, the processing shown in FIG. 11 is temporarily ended. In this case, for example, when remote exiting is performed, the reservation instruction may be acquired again. Note that the waiting time when the determination in step S14 is negative may be, for example, shorter than the waiting time when the determination in step S12 is negative. This is because the vehicle 10 is already in a movable state during the waiting time in step S14, which is a different vehicle state from the state in step S12, in which each ECU and the like are not started (that is, the movement preparation state).

If it is determined that the exit instruction has been acquired (Yes in step S14), the control device 20 starts the movement (exiting) of the vehicle 10 (step S15). That is, the control device 20 performs the driving control, braking control, steering control, and the like via the drive ECU 130, the brake ECU 132, the EPS_ECU 108, and the like, to perform remote exiting from the parking position 210 to the exit position 220 designated by the user.

Next, the processing of the terminal device 60 of the user will be described. As described above, the terminal device 60 gives the vehicle start instruction and the exit instruction to the vehicle 10. Here, a flow of the processing will be described using a flowchart.

FIG. 13 shows an example of giving the vehicle start instruction and the exit instruction based on the position information. Note that the processing shown in FIG. 13 is started when the state of the vehicle 10 is the first state, for example.

Specifically, first, the processor 61 acquires the position information of the terminal device 60 (step S20). For example, the processor 61 acquires the position information of the terminal device 60 based on position information obtained from the GNSS receiver (not illustrated) included in the terminal device 60.

Next, based on the position information of the terminal device 60 acquired in step S20, the processor 61 determines whether the position of the terminal device 60 is outside the first range C1 from the exit position 220 and within the second range C2 (step S21).

If it is determined that the position of the terminal device 60 is outside the first range C1 and within the second range C2 (Yes in step S21), the processor 61 executes a response request to the terminal device 60 for the vehicle start instruction (step S22).

Next, the processor 61 determines whether a positive response instruction has been received in response to the response request in step S22 (step S23). For example, if the user responds in the terminal device 60 by giving the vehicle start instruction, the determination is positive.

Therefore, if a positive response instruction has been received in response to the response request (Yes in step S23), the processor 61 gives the vehicle start instruction to the vehicle 10 (step S24).

Then, if the vehicle start instruction is given, the processor 61 gives the exit instruction to the vehicle 10 (step S25). That is, the exit instruction is received from the user, and then the exit instruction is given to the vehicle 10.

On the other hand, in the above-mentioned step S21, if it is determined that the position of the terminal device 60 is outside the first range C1 and not within the second range C2 (No in step S21), the processor 61 determines whether the position of the terminal device 60 is within the first range C1 based on the position information of the terminal device 60 (step S26).

If it is determined that the position of the terminal device 60 is within the first range C1 (Yes in step S26), the processor 61 gives the vehicle start instruction to the vehicle 10 (step S24).

On the other hand, if it is determined that the position of the terminal device 60 is not within the first range C1 (No in step S26), the processor 61 temporarily ends the processing in FIG. 13.

Note that in the above-mentioned step S23, if there is no response instruction to the response request for the vehicle start instruction, the processor 61 also temporarily ends the processing in FIG. 13. Note that a case of no indication may include a case where a negative response has been given in response to the response request.

Next, with reference to FIG. 14, processing of giving the vehicle start instruction and the exit instruction based on the payment information will be described. Note that the example illustrated in FIG. 14 is almost the same as the processing described with reference to FIG. 13. In the example illustrated in FIG. 14, the processing steps include step S30 to step S35, but only step S30 is different from the example in FIG. 13, and step S31 to step S34 are the same as step S22 to step S25 in the example in FIG. 13. Therefore, only step S30, which is different from the example in FIG. 13, will be described here.

In step S30, the processor 61 acquires the payment information of the terminal device 60. That is, the processor 61 acquires the payment information such as using the terminal device 60 to perform credit card payment or electronic money payment.

Then, in step S31, the processor 61 makes a response request to the user for the vehicle start instruction. Note that as described above, if there are a plurality of pieces of payment information, it can be assumed that there is a relatively higher possibility of performing remote exiting as compared with when there is only one piece of payment information, and the response request does not need to be made. In other words, in this case, the processing of step S31 may be omitted.

The processing from step S32 to step S34 is the same as the processing from step S23 to step S25 described above, and therefore the description thereof will be omitted.

As described above, in the above embodiment, the control device 20 of the vehicle 10 can acquire the reservation instruction to move the vehicle 10 before acquiring the exit instruction when performing the remote exiting. That is, before the user calls the vehicle 10 at the predetermined exit position 220, the control device 20 receives the reservation instruction inside the vehicle during parking, for example. In this way, the user can perform the operations corresponding to the reservation instruction during parking, among the series of operations for the remote exiting.

Then, after acquiring the reservation instruction, the control device 20 causes the vehicle 10 to transition to the first state, which is the movement preparation state. That is, the ignition and each ECU of the vehicle 10 are turned off while communication with the terminal device 60 is possible. Furthermore, after acquiring the vehicle start instruction based on the position information, the payment information, or the like of the terminal device 60 of the user while the vehicle 10 is in the first state, the control device 20 causes the vehicle 10 to transition from the first state to the second state. That is, the control device 20 starts devices such as each ECU of the vehicle 10 to set the vehicle 10 to a movable state. Then, after acquiring the exit instruction (in other words, a calling operation) from the user, the control device 20 moves the vehicle 10 to the exit position 220.

In this way, in the embodiment, some operations (operations related to the reservation instruction) can be received in advance, or some operations (vehicle start instruction) are coordinated with the use of the terminal device 60, with no need to consecutively perform the series of operations for the remote exiting. As a result, when the user actually calls the vehicle 10, the remote exiting can be achieved by performing only the operations related to the exit instruction. In other words, if all of this series of operations are to be performed when the vehicle 10 is called, time is required, but in the embodiment, only the operations related to the exit instruction needs to be performed when calling the vehicle 10, which significantly reduces the time required. In other words, even though a total time required for the series of operations for the remote exiting remains the same, the time required during the actual calling can be reduced. Therefore, the convenience of the remote exiting can be improved as compared with the configuration in which all operations are performed during the actual calling.

For example, when the user calls the vehicle 10 after shopping at a shopping mall or the like, it can be assumed that the user is carrying a large amount of goods or the like, while in such a situation, the reservation instruction and the vehicle start instruction have already been completed, so the user can easily call the vehicle 10. Furthermore, by being able to call the vehicle 10 easily in this way, the irritation of the user caused by the operations for the remote exiting can be reduced.

### Modification

Next, a modification will be described. In the above embodiment, an example has been described in which the control device 20 acquires the vehicle start instruction, and then acquires the exit instruction to move the vehicle 10 from the parking position 210 to the exit position 220. However, after the vehicle start instruction is acquired, each ECU of the vehicle 10 and the like may be started, and the movement of the vehicle 10 may directly be started. That is, the vehicle start instruction may include the exit instruction to move the vehicle 10 from the parking position 210 to the exit position 220. This is because the vehicle start instruction from the user can be assumed to indicate an intention to call the vehicle 10 to the exit position 220.

In other words, after acquiring the vehicle start instruction after the reservation instruction while the vehicle 10 is in the first state, the control device 20 causes the vehicle 10 to transition from the first state to the second state and moves the vehicle 10 to the exit position 220.

The reservation instruction may include the above-mentioned authentication operation between the terminal device 60 and the vehicle 10, the agreement operation of receiving the agreement to the disclaimer, the operation of setting the exit position, and, for example, an operation of designating a time. The operation of designating a time is an operation of setting an exit time. For example, the control device 20 uses the function of the display control unit 59 to display an operation screen for time designation on the touch panel 42, so as to receive the setting of the exit time from the user. In this case, the response request for the vehicle start instruction may be displayed on the terminal screen 64a of the terminal device 60 a few minutes before the set exit time, and a response request may be made to the user. Then, after the response instruction is received in response to the response request, the vehicle start instruction may be given.

Although a plurality of examples of the reservation instruction have been described above, not all of these examples may be included in the reservation instruction.

In the above-described embodiment, the vehicle start instruction is configured to be acquired based on the position information or the payment information of the terminal device 60, but the vehicle start instruction may also be configured to be acquired based on a plurality of pieces of information (for example, based on both the position information and the payment information). By obtaining the vehicle start instruction based on a plurality of pieces of information, it is possible to increase the possibility of giving the vehicle start instruction without making the response request to the user for giving the vehicle start instruction, for example. In other words, if the plurality of pieces of information satisfy a predetermined condition, it can be determined that there is a higher possibility of performing the remote exiting, and it becomes possible to give the vehicle start instruction to the vehicle 10 without confirming the vehicle start instruction.

Although the embodiment of the present disclosure has been described above with reference to the drawings, it goes without saying that the present invention is not limited to the embodiment described above. It is apparent that those skilled in the art may conceive of various modifications and changes within the scope described in the claims, and it is understood that such modifications and changes naturally fall within the technical scope of the present invention. In addition, constituent elements in the embodiment described above may be freely combined without departing from the gist of the present invention.

The configurations of the embodiment described above may share functions or may be implemented by fewer devices and the like. For example, at least a part of the configurations of the vehicle 10 and the terminal device 60 may be implemented by another device or the like.

Further, a part of the configurations of the above-described embodiment may be omitted, or the processing may be changed or omitted.

In the above embodiment, an example in which the moving object is a vehicle has been described, but the present invention is not limited thereto. For example, the moving object may be a vehicle such as a motorcycle or a Segway.

The control method described in the above embodiment may be implemented by executing a control program prepared in advance on a computer. The control program is stored in a computer-readable storage medium and executed by being read from the storage medium. The control program may be provided in a form of being stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements or the like in the embodiment described above are shown in parentheses, the present invention is not limited thereto.

(1) A control device (control device 20) for controlling a moving object (vehicle 10) capable of autonomously moving from a parking position (parking position 210) to a predetermined exit position (exit position 220), the control device including a processor (acquisition unit 55, moving object control unit 57),

the processor configured to acquire an instruction from a user for the moving object, and control the moving object based on the acquired instruction, in which

the processor is capable of acquiring a reservation instruction before acquiring an exit instruction, the reservation instruction being an instruction to move the moving object, the exit instruction being an instruction to move the moving object parked at the parking position to the predetermined exit position, and

the processor causes the moving object to transition to a first state in response to the processor acquiring the reservation instruction, the first state being a movement preparation state, and causes the moving object to transition from the first state to a second state in response to the processor acquiring a predetermined instruction after the reservation instruction (vehicle start instruction) when the moving object is in the first state, the second state being a state in which the moving object is moved.

According to (1), the control device can acquire the reservation instruction to move the moving object before acquiring the exit instruction for the moving object. That is, before the user calls the moving object at the predetermined exit position, the control device receives the reservation instruction inside the vehicle during parking, for example. In this way, the user can perform the operations corresponding to the reservation instruction during parking, among the series of operations for the remote exiting. Then, after acquiring the reservation instruction, the control device causes the moving object to transition to the first state, which is the movement preparation state. Furthermore, after acquiring the predetermined instruction while the moving object is in the first state, the control device causes the moving object to transition to the second state in which the moving object is moved, for example, according to the predetermined instruction.

In this way, some operations (operations related to the reservation instruction) can be received in advance, or some operations (predetermined instruction) are coordinated with the use of the external device, with no need to consecutively perform the series of operations for the remote exiting. As a result, when the user actually calls the moving object, the remote exiting can be achieved by performing only the operations related to the exit instruction. In other words, if all of this series of operations are to be performed when the moving object is called, time is required, but according to the configuration in (1), the time required can be significantly reduced by enabling the moving object to be moved, when only the operations related to the exit instruction, for example, is performed. Therefore, the convenience of the remote exiting can be improved as compared with the configuration in which all operations are performed during the actual calling, and the irritation of the user caused by the operations for performing the remote exiting can be reduced.

(2) The control device according to (1), in which

the processor causes the moving object to transition from the first state to the second state in response to the processor acquiring the predetermined instruction after the reservation instruction when the moving object is in the first state, the second state being a state in which the moving object is moved in response to the exit instruction.

According to (2), after acquiring the predetermined instruction while the moving object is in the first state, the control device causes the moving object to transition to the second state in which the moving object is moved according to the predetermined instruction. In this way, the remote exiting can be achieved by performing only the operations related to the exit instruction, thereby reducing the time required for the remote exiting.

(3) The control device according to (1), in which

the processor causes the moving object to transition from the first state to the second state and to move to the predetermined exit position, in response to the processor acquiring the predetermined instruction after the reservation instruction when the moving object is in the first state, the second state being a state in which the moving object is moved in response to the exit instruction.

According to (3), after acquiring the predetermined instruction after the reservation instruction, the state transitions to the second state in which the moving object is moved, and the moving object is moved to the exit position. In this way, the remote exiting can be achieved by performing only the operations related to the exit instruction. the predetermined instruction includes the instruction to move the moving object to the exit position, thereby reducing the time required to give the exit instruction.

(4) The control device according to any of (1) to (3), in which the first state is a state in which the moving object is in a stop state and is capable of communicating with an external device (terminal device 60).

According to (4), since communication with the external device is possible, for example, the user can give the predetermined instruction to the moving object from outside the vehicle.

(5) The control device according to any of (1) to (3), in which the second state is a state in which the control device of the moving object is started, and the moving object is movable.

According to (5), since the moving object is in a movable state in which the control device is started, for example, since the control device and the like have already been started when the exit instruction is given, the time required for the moving object to start moving is shorter as compared with a case where the control device needs to be started when the exit instruction is given.

(6) The control device according to any of (1) to (3), further including:

a memory (memory 54) that stores map information, in which

the processor (display control unit 59) is configured to control a display (touch panel 42) that displays predetermined information and receives input, and in which

when the reservation instruction is acquired, the processor performs a control to display a parking lot map of a parking lot where the moving object is parked based on the map information, and receives a designated predetermined position on the parking lot map as the predetermined exit position.

According to (6), the user can designate the exit position by operating the display of the moving object, which increases the possibility of operating on a larger screen as compared with a case of, for example, designating the exit position on the terminal device or the like of the user.

(6) The control device according to any of (1) to (3), further including:

a memory (memory 54) that stores route information on a route on which the moving object has traveled in the past, in which

the processor (display control unit 59) is configured to control a display (touch panel 42) that displays predetermined information and receives input, and in which

information on a route including a start position and an end position of parking is stored in the route information, and

the processor performs a control to display a parking lot map based on the route information and receives the end position designated on the parking lot map as the predetermined exit position when the processor acquires the reservation instruction.

According to (7), information on past parking can be used, so that the user can easily designate the exit position as compared with, for example, the configuration in (5).

(8) A terminal device (terminal device 60) capable of executing an instruction to cause a moving object to perform autonomous movement from a parking position (parking position 210) to a predetermined exit position (exit position 220), the terminal device including

a processor (processor 61) that controls the terminal device, in which

the processor gives, to the moving object that has transitioned to a first state by acquiring a reservation instruction to move the moving object before acquiring an exit instruction to move the moving object parked at the parking position to the predetermined exit position, a predetermined instruction that causes the moving object to transition from the first state to a second state, the first state being a movement preparation state, the second state being a state in which the moving object is moved, and in which

the processor gives the predetermined instruction (vehicle start instruction) to the moving object according to a state of the terminal device.

According to (8), the user can give the predetermined instruction to the moving object via the terminal device, that is, can give the instruction related to the remote exiting while being away from the moving object.

(9) The terminal device according to (8), in which

the processor acquires position information of the terminal device,

when the terminal device is positioned outside a first range (first range C1) and within a second range (second range C2) from the predetermined exit position based on the position information, the processor executes a response request to a user for giving the predetermined instruction, and

when a response instruction to the response request from the user is received, the processor gives the predetermined instruction to the moving object.

According to (9), the predetermined instruction can be given based on the position information of the terminal device. In addition, when the position of the terminal device is outside the first range and within the second range, the response request is made for giving the predetermined instruction. In this way, it is possible to prevent the exit instruction from being given under a state in which there is no intention of exiting, such as when the terminal device is outside the first range and within the second range, as the user moves.

(10) The terminal device according to (9), in which

the processor gives the predetermined instruction to the moving object without executing the response request when the terminal device is positioned within the first range for a predetermined time.

According to (10), the predetermined instruction can be given based on the position information of the terminal device. In addition, when the position of the terminal device is within the first range, the predetermined instruction is given to the moving object without giving the response request. In this way, the user can give the predetermined instruction by moving himself or herself, that is, can give the predetermined instruction without giving the response instruction to the response request. As a result, the convenience of the remote exiting can be improved.

(11) The terminal device according to (8), in which

the processor acquires payment information in the terminal device,

the processor executes a response request to the user for giving the predetermined instruction based on the acquired payment information, and

after receiving a response instruction to the response request from the user, the processor gives the predetermined instruction to the moving object.

According to (11), the predetermined instruction can be given based on the payment information of the terminal device.

(12) The terminal device according to (11), in which

the processor gives the predetermined instruction to the moving object without executing the response request when the acquired payment information satisfies a predetermined condition.

According to (12), when the payment information of the terminal device satisfies the predetermined condition (for example, when there are a plurality of pieces of payment information), the predetermined instruction is given to the moving object without making the response request. In this way, the user can give the predetermined instruction without giving the response instruction to the response request. As a result, the convenience of the remote exiting can be improved.

(13) The terminal device according to any of (9) to (12), in which

the predetermined instruction includes an exit instruction to move the moving object from the parking position to the predetermined exit position.

According to (13), by including the exit instruction in the predetermined instruction, the user can reduce the operations related to the exit instruction.

(14) A control method for a computer to control a moving object (vehicle 10) capable of autonomously moving from a parking position (parking position 210) to a predetermined exit position (exit position 220), including:

acquiring an instruction from a user for the moving object,

controlling the moving object based on the acquired instruction,

acquiring a reservation instruction before acquiring an exit instruction, the reservation instruction being an instruction to move the moving object, the exit instruction being an instruction to move the moving object parked at the parking position to the predetermined exit position, and

causing the moving object to transition to a first state in response to acquiring the reservation instruction, the first state being a movement preparation state, and causing the moving object to transition from the first state to a second state in response to acquiring a predetermined instruction after the reservation instruction (vehicle start instruction) when the moving object is in the first state, the second state being a state in which the moving object is moved according to the exit instruction.

According to (14), it is possible to acquire the reservation instruction to move the moving object before acquiring the exit instruction for the moving object. That is, before the user calls the moving object at the predetermined exit position, the reservation instruction can be received inside the vehicle during parking, for example. In this way, the user can perform the operations corresponding to the reservation instruction during parking, among the series of operations for the remote exiting. Then, after acquiring the reservation instruction, the moving object transitions to the first state, which is the movement preparation state. Furthermore, after acquiring the predetermined instruction while the moving object is in the first state, the moving object transitions to the second state in which the moving object is moved, for example, according to the predetermined instruction.

In this way, some operations (operations related to the reservation instruction) can be received in advance, or some operations (predetermined instruction) are coordinated with the use of the external device, with no need to consecutively perform the series of operations for the remote exiting. As a result, when the user actually calls the moving object, the remote exiting can be achieved by performing only the operations related to the exit instruction. In other words, if all of this series of operations are to be performed when the moving object is called, time is required, but the time required can be significantly reduced by enabling the moving object to be moved, when only the operations related to the exit instruction, for example, is performed. Therefore, the convenience of the remote exiting can be improved as compared with the configuration in which all operations are performed during the actual calling, and the irritation of the user caused by the operations for performing the remote exiting can be reduced.

(15) A non-transitory computer-readable storage medium storing a control program for a computer to perform processing, the computer configured to control a moving object (vehicle 10) capable of autonomously moving from a parking position (parking position 210) to a predetermined exit position (exit position 220), the processing including:

acquiring an instruction from a user for the moving object,

controlling the moving object based on the acquired instruction,

acquiring a reservation instruction before acquiring an exit instruction, the reservation instruction being an instruction to move the moving object, the exit instruction being an instruction to move the moving object parked at the parking position to the predetermined exit position, and

causing the moving object to transition to a first state in response to acquiring the reservation instruction, the first state being a movement preparation state, and causing the moving object to transition from the first state to a second state in response to acquiring a predetermined instruction after the reservation instruction (vehicle start instruction) when the moving object is in the first state, the second state being a state in which the moving object is moved according to the exit instruction.

According to (15), it is possible to acquire the reservation instruction to move the moving object before acquiring the exit instruction for the moving object. That is, before the user calls the moving object at the predetermined exit position, the reservation instruction can be received inside the vehicle during parking, for example. In this way, the user can perform the operations corresponding to the reservation instruction during parking, among the series of operations for the remote exiting. Then, after acquiring the reservation instruction, the moving object transitions to the first state, which is the movement preparation state. Furthermore, after acquiring the predetermined instruction while the moving object is in the first state, the moving object transitions to the second state in which the moving object is moved, for example, according to the predetermined instruction.

In this way, some operations (operations related to the reservation instruction) can be received in advance, or some operations (predetermined instruction) are coordinated with the use of the external device, with no need to consecutively perform the series of operations for the remote exiting. As a result, when the user actually calls the moving object, the remote exiting can be achieved by performing only the operations related to the exit instruction. In other words, if all of this series of operations are to be performed when the moving object is called, time is required, but the time required can be significantly reduced by enabling the moving object to be moved, when only the operations related to the exit instruction, for example, is performed. Therefore, the convenience of the remote exiting can be improved as compared with the configuration in which all operations are performed during the actual calling, and the irritation of the user caused by the operations for performing the remote exiting can be reduced.

(16) A control method for a computer of a terminal device (terminal device 60) to execute an instruction to cause a moving object (vehicle 10) to perform autonomous movement from a parking position (parking position 210) to a predetermined exit position (exit position 220), the control method including:

giving a predetermined instruction (vehicle start instruction) to the moving object to make the autonomous movement possible according to a state of the terminal device.

According to (16), the user can give the predetermined instruction to the moving object via the terminal device, that is, can give the instruction related to the remote exiting while being away from the moving object.

(17) A non-transitory computer-readable storage medium storing a control program for a terminal device (terminal device 60), the control program causing a computer of the terminal device to perform processing, the computer of the terminal device executing an instruction to cause a moving object (vehicle 10) to perform autonomous movement from a parking position (parking position 210) to a predetermined exit (exit position 220) position, the processing including:

giving a predetermined instruction (vehicle start instruction) to the moving object to make the autonomous movement possible according to a state of the terminal device.

According to (17), the user can give the predetermined instruction to the moving object via the terminal device, that is, can give the instruction related to the remote exiting while being away from the moving object.

What is claimed is:

1. A control device for controlling a moving object capable of autonomously moving from a parking position to a predetermined exit position, the control device comprising a processor,
the processor configured to acquire an instruction from a user for the moving object, and control the moving object based on the acquired instruction, wherein
the processor is capable of acquiring a reservation instruction before acquiring an exit instruction, the reservation instruction being an instruction to move the moving object, the exit instruction being an instruction to move the moving object parked at the parking position to the predetermined exit position, and
the processor causes the moving object to transition to a first state in response to the processor acquiring the reservation instruction, the first state being a movement preparation state, and causes the moving object to transition from the first state to a second state in response to the processor acquiring a predetermined instruction after the reservation instruction when the moving object is in the first state, the second state being a state in which the moving object is moved.

2. The control device according to claim 1, wherein
the processor causes the moving object to transition from the first state to the second state in response to the processor acquiring the predetermined instruction after the reservation instruction when the moving object is in the first state, the second state being a state in which the moving object is moved in response to the exit instruction.

3. The control device according to claim 1, wherein
the processor causes the moving object to transition from the first state to the second state and to move to the predetermined exit position, in response to the processor acquiring the predetermined instruction after the reservation instruction when the moving object is in the first state, the second state being a state in which the moving object is moved in response to the exit instruction.

4. The control device according to claim 1, wherein
the first state is a state in which the moving object is in a stop state and is capable of communicating with an external device.

5. The control device according to claim 1, wherein
the second state is a state in which the control device of the moving object is started, and the moving object is movable.

6. The control device according to claim 1, further comprising:
a memory that stores map information, wherein
the processor is configured to control a display that displays predetermined information and receives input, and wherein
when the reservation instruction is acquired, the processor performs a control to display a parking lot map of a parking lot where the moving object is parked based on the map information, and receives a designated predetermined position on the parking lot map as the predetermined exit position.

7. The control device according to claim 1, further comprising:
a memory that stores route information on a route on which the moving object has traveled in the past, wherein
the processor is configured to control a display that displays predetermined information and receives input, and wherein
information on a route including a start position and an end position of parking is stored in the route information, and
the processor performs a control to display a parking lot map based on the route information and receives the end position designated on the parking lot map as the predetermined exit position when the processor acquires the reservation instruction.

8. A terminal device capable of executing an instruction to cause a moving object to perform autonomous movement from a parking position to a predetermined exit position, the terminal device comprising:
a processor that controls the terminal device,
wherein the processor gives, to the moving object that has transitioned to a first state by acquiring a reservation instruction to move the moving object before acquiring an exit instruction to move the moving object parked at the parking position to the predetermined exit position, a predetermined instruction that causes the moving object to transition from the first state to a second state, the first state being a movement preparation state, the second state being a state in which the moving object is moved, and
wherein the processor gives a predetermined instruction to the moving object to make the autonomous movement possible according to a state of the terminal device.

9. The terminal device according to claim 8, wherein
the processor acquires position information of the terminal device,
when the terminal device is positioned outside a first range and within a second range from the predetermined exit position based on the position information, the processor executes a response request to a user for giving the predetermined instruction, and
when a response instruction to the response request from the user is received, the processor gives the predetermined instruction to the moving object.

10. The terminal device according to claim 9, wherein
the processor gives the predetermined instruction to the moving object without executing the response request when the terminal device is positioned within the first range for a predetermined time.

11. The terminal device according to claim 8, wherein
the processor acquires payment information in the terminal device,
the processor executes a response request to the user for giving the predetermined instruction based on the acquired payment information, and
after receiving a response instruction to the response request from the user, the processor gives the predetermined instruction to the moving object.

12. The terminal device according to claim 11, wherein
the processor gives the predetermined instruction to the moving object without executing the response request when the acquired payment information satisfies a predetermined condition.

13. The terminal device according to claim 9, wherein
the predetermined instruction includes an exit instruction to move the moving object from the parking position to the predetermined exit position.

14. A control method for a computer to control a moving object capable of autonomously moving from a parking position to a predetermined exit position, comprising:
acquiring an instruction from a user for the moving object;
controlling the moving object based on the acquired instruction;
acquiring a reservation instruction before acquiring an exit instruction, the reservation instruction being an instruction to move the moving object, the exit instruction being an instruction to move the moving object parked at the parking position to the predetermined exit position; and
causing the moving object to transition to a first state in response to acquiring the reservation instruction, the first state being a movement preparation state, and causing the moving object to transition from the first state to a second state in response to acquiring a predetermined instruction after the reservation instruction when the moving object is in the first state, the second state being a state in which the moving object is moved.

15. A non-transitory computer-readable storage medium storing a control program for a computer to perform processing, the computer configured to control a moving object capable of autonomously moving from a parking position to a predetermined exit position, the processing comprising:
acquiring an instruction from a user for the moving object;
controlling the moving object based on the acquired instruction;
acquiring a reservation instruction before acquiring an exit instruction, the reservation instruction being an instruction to move the moving object, the exit instruction being an instruction to move the moving object parked at the parking position to the predetermined exit position; and
causing the moving object to transition to a first state in response to acquiring the reservation instruction, the first state being a movement preparation state, and causing the moving object to transition from the first state to a second state in response to acquiring a predetermined instruction after the reservation instruction when the moving object is in the first state, the second state being a state in which the moving object is moved.
